(19) United States
(12) Patent Application Publication
(10) Pub. No.: US 2021/0104356 A1
(43) Pub. Date: Apr. 8, 2021

(54) CHOKE COIL

(71) Applicant: MODA-INNOCHIPS CO., LTD., Ansan-Si, Gyeonggi-Do (KR)

(72) Inventors: Gyeong Tae KIM, Ansan-Si, Gyeonggi-Do (KR); Sang Hyun KIM, Gwangju-Si, Gyeonggi-Do (KR)

(21) Appl. No.: 16/608,183

(22) PCT Filed: May 10, 2018
(86) PCT No.: PCT/KR2018/005375

§ 371 Date: Oct. 24, 2019

(30) Foreign Application Priority Data
May 12, 2017 (KR) 10-2017-0059289
Sep. 29, 2017 (KR) 10-2017-0127910

(51) Int. Cl. H01F 27/28; H01F 27/29; H01F 17/04; H01F 41/06

(52) U.S. Cl. CPC H01F 27/2828; H01F 27/29; H01F 2017/0093; H01F 41/06; H01F 17/04

(57) ABSTRACT

The present disclosure provides a choke coil including a core, a flange provided on each of both end portions of the core in one direction, a terminal electrode coupled to the flange, a wire wound around the core and having end portions each led out to the terminal electrode, and a wire accommodation part configured to accommodate each of the end portions of the wire.

### TECHNICAL FIELD

The present disclosure relates to a choke coil, and more particularly, to a choke coil capable of assuring stable characteristics by being mounted on a vehicle or the like.

### BACKGROUND ART

In a choke coil according to the related art, terminal electrodes were formed on flanges of a drum core by plating or soldering, a pair of wires were wound around the drum core, and then, ends of the wires were soldered to the terminal electrodes. The terminal electrodes of such choke coils were attached by soldering to a printed wiring board of a vehicle.

When the choke coil according to the related art is mounted on a vehicle, reliability under a wide range of temperatures should be assured. However, defects, such as detachment of the terminal electrode from the printed wiring board or a crack in the drum core, occur.

Thus, recently, a choke coil is being manufactured such that “C”-shaped terminal electrodes are inserted into and fastened to flanges, ends of a wire are fixed to portions of the terminal electrodes, and then, weld parts are formed on upper portions of the terminal electrodes by using laser welding or arc welding. That is, in the choke coil according to the related art, the terminal electrodes are provided on the upper and lower portions of the flanges. Therefore, first and second wires wound around a core are led out to the upper outside of the core.

Meanwhile, the wires led out to the upper outside of the terminal electrodes are pressed and fixed by extension parts extending from the terminal electrodes. However, since the extension parts press the wires, the wires are crushed. That is, the original shapes of the circular wires are changed such that, for example, the wires are crushed by being pressed by the extension parts. At this point, the changed shapes of the wires vary according to the pressing force. In addition, the tensile force of the wires vary according to the pressing force, and the larger the pressing force, the weaker the tensile force. In order to minimize the shape deformation of the wires, the wires may be weakly pressed. In this case, the terminal electrodes cannot sufficiently press the wires, so that the wires are not fixed, and there may be a case in which the wires wound around the core are loosened by tension. Thus, the wires should be pressed by at least a predetermined pressure, but there may be limitations in that for example, the wires are weakened by the pressing force and are thereby cut during operation.

In addition, when pressing the wires by using the extension parts, there may be a limitation in that the wires are pushed or deviate from the initial positions. Thus, a positional deviation of the wires occur, so that the same quality cannot be expected for a plurality of products in which the positions of weld parts vary when the weld parts are formed to couple the wires to the terminal electrodes in a subsequent process.

### PRIOR ART DOCUMENT

Japanese Patent Laid-open Publication No. 2003-022916

### DISCLOSURE OF THE INVENTION

### Technical Problem

The present disclosure provides a choke coil capable of minimizing a limitation due to shape deformation and positional misalignment of a wire.

The present disclosure also provides a choke coil capable of minimizing the shape deformation of a wire and preventing the positional misalignment of the wire by forming, on a portion of a terminal electrode, a wire accommodation part which accommodates at least a portion of the wire.

### Technical Solution

In accordance with an exemplary embodiment, a choke coil includes: a core; a flange provided on each of both end portions of the core in one direction; a terminal electrode coupled to the flange; a wire wound around the core and having end portions each led out to the terminal electrodes; and a wire accommodation part configured to accommodate each of the end portions of the wire.

The wire accommodation part may be provided on at least a portion of the terminal electrodes.

The terminal electrode may include a terminal brought into contact with a side surface or one vertical surface of each of the flanges, and the wire may be led out on to the terminal.

The choke coil may further include an extension part extending in one direction from the terminal and bent toward the terminal.

The wire accommodation part may be provided on at least one of the terminal and the extension part.

The wire accommodation part may include a groove having a depth of 0.2 times to 1 times a wire diameter and a width of 0.2 times to 2 times the wire diameter.

The groove may be provided to at least one of one surface of the terminal and one surface of the extension part.

The wire accommodation part may further include a protrusion part opposed to the groove and provided on the other surface of the terminal and the other surface of the extension part.

The flange may further include a guide groove recessed corresponding to the protrusion part of the terminal and configured to accommodate the protrusion part.

The choke coil may further include an opening provided to overlap the wire accommodation part.

The choke coil may further include at least one of a weld part formed on the wire accommodation part, and a lid part provided to cover the core.

### Advantageous Effects

Choke coils in accordance with exemplary embodiments each include wire accommodation parts formed on at least a portion of terminal electrodes, and a wire is led out so that at least a portion of the wire is accommodated in the wire accommodation part. At least a portion of the wire, for example, a least a portion of the diameter of the wire is accommodated in the wire accommodation part, and thus, when the wire is pressed, shape deformation of the wire may be minimized Thus, the tensile force of the wire in improved, resistance against shock and vibration is thereby improved, and the reliability of the choke coil may be improved.

In addition, since the wire is led out so as to be accommodated in the wire accommodation part, the position of the wire may be fixed and the positional misalignment of the wire may be prevented. Accordingly, since positional deviation of the wire does not occur, a weld parts at which the wire and the terminal electrodes are coupled may be formed at the same position, and thus, a plurality of products may have the same quality.

### BRIEF DESCRIPTION OF THE DRAWINGS

Exemplary embodiments can be understood in more detail from the following description taken in conjunction with the accompanying drawings, in which:

FIG. 1 is an assembled perspective view of a choke coil in accordance with a first embodiment;

FIGS. 2 to 4 are partial exploded perspective view, an assembled perspective view, and a side view of a choke coil in accordance with the first exemplary embodiment;

FIGS. 5 and 6 are side views of a terminal electrode and a wire accommodation part in accordance with the first exemplary embodiment;

FIGS. 7 to 11 are views illustrating modified exemplary embodiments of a terminal electrode and a wire accommodation part in accordance with the first exemplary embodiment;

FIGS. 12 and 13 are an exploded perspective view and an assembled perspective view of a choke coil in accordance with a second exemplary embodiment;

FIGS. 14 and 15 are a perspective view and one side view of a choke coil during some processes in accordance with a third exemplary embodiment;

FIGS. 16 to 17 are a perspective view and a partial enlarged view of a choke coil during some processes in accordance with the third exemplary embodiment; and

FIG. 18 is a partial photograph of a choke coil in accordance with exemplary embodiments.

### DETAILED DESCRIPTION OF EMBODIMENTS

Hereinafter, exemplary embodiments will be described in detail with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art.

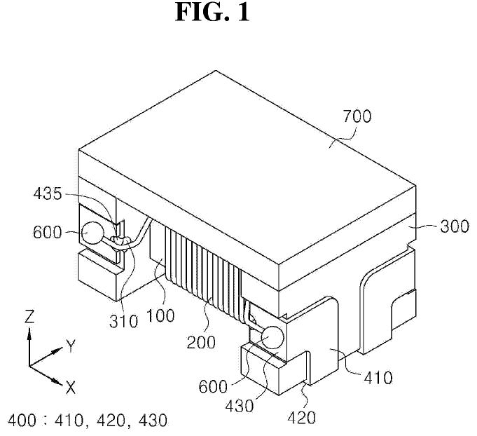

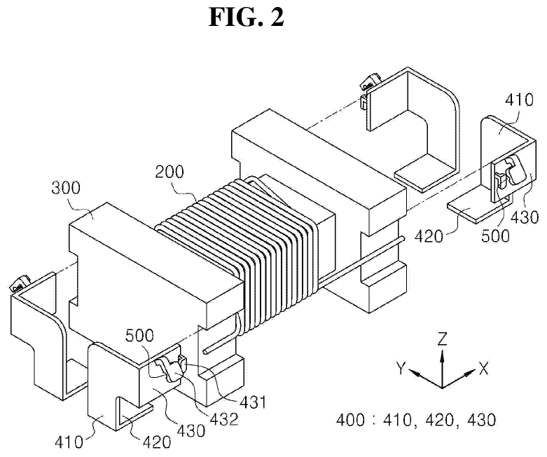

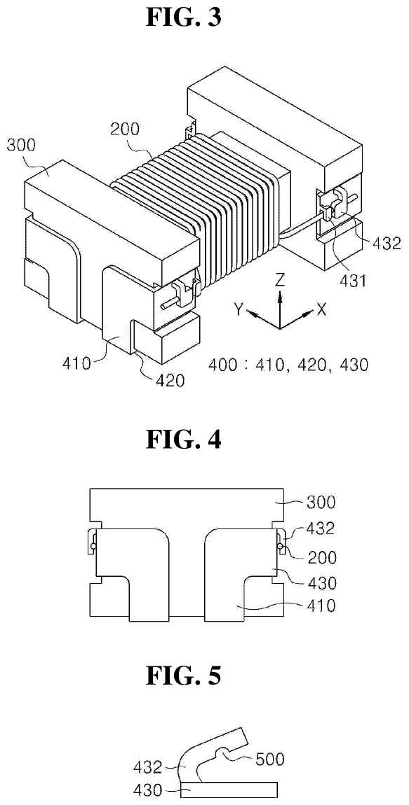

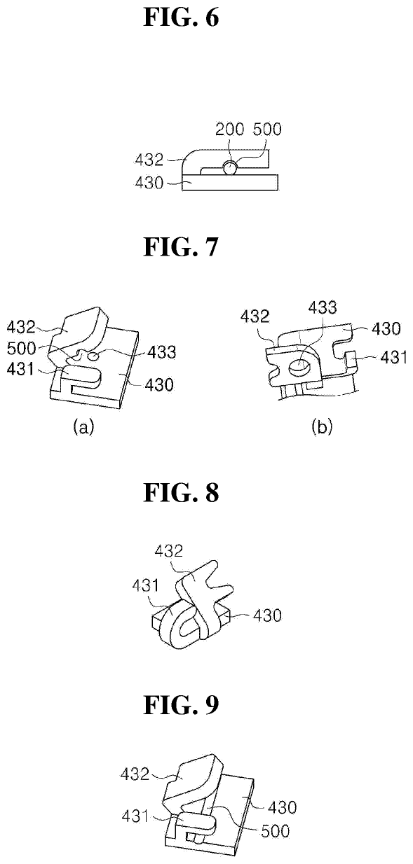

FIG. 1 is an assembled perspective view of a choke coil in accordance with a first embodiment. In addition, FIGS. 2 to 4 are an exploded perspective view, an assembled perspective view, and a side view of a choke coil during some processes in accordance with the first exemplary embodiment. In addition, FIGS. 5 and 6 are side views of terminal electrodes and wire accommodation parts in accordance with the first exemplary embodiment, FIGS. 7 to 9 are views illustrating modified exemplary embodiments of terminal electrodes in accordance with the first exemplary embodiment.

Referring to FIGS. 1 to 9, a choke coil in accordance with a first exemplary embodiment may include: a core 100; a wire 200 wound around the core 100; flanges 300 provided on both end portions of the core 100; terminal electrodes 400 fastened to the flanges 300; and wire accommodation parts 500 configured to accommodate at least a portion of the wire 200 led out from the core 100. Here, the wire accommodation parts 500 accommodates ends of the wire 200 led out onto the terminal electrodes 400. In addition, the choke coil may further include weld parts 600 formed on the terminal electrodes 400, and a lid part 700 provided over the core 100. That is, the choke coil may selectively include at least any one of the weld parts 600 and the lid part 700. Thus, FIGS. 2 and 3 illustrate the choke coil which is not provided with the weld parts 600 and the lid part 700, and FIG. 1 illustrates the choke coil provided with the weld parts 600 and the lid part 700. That is, as illustrated in FIGS. 2 and 3, when the weld parts 600 are formed on the terminal electrodes 400 onto which the wire 200 is fixed, and the lid part 700 is formed so as to be brought into contact with the upper surface of the flanges 300, the choke coil is manufactured in a shape illustrated in FIG. 1. 1. Core

The core 100 may be provided in an approximately hexahedral shape, and the wire 200 may be wound to be brought into contact with and surround the core 100. For example, the core 100 has approximately rectangular shapes cross-sectional shapes in the longitudinal direction (X-direction) and the width direction (Y-direction), respectively, and the core 100 may be provided in a larger size in the X-direction than in the Y-direction. At this point, the direction in which the flanges 300 are provided is referred to as the longitudinal direction (the X-direction) and the direction perpendicular to the longitudinal direction is referred to as the width direction (the Y-direction). That is, the core 100 may be provided with: first and second surfaces (that is, front and rear surfaces) facing each other in the X-direction; third and fourth surfaces (that is, two side surfaces) facing each other in the Y-direction; and fifth and sixth surfaces facing each other in a Z-direction (that is, upper and lower surfaces), wherein the distance between the first and second surfaces may be greater than the widths of the third and fourth surfaces. In addition, the core 100 may be formed such that edge portions thereof are formed to be rounded and have predetermined inclination. That is, the edge portions between the third to sixth surfaces (that is, between the two side surfaces and the upper and lower surfaces) may be formed to be rounded and to have the predetermined inclination. As such, the core 100 is formed to have the rounded edges, whereby the limitations such as disconnection of the wire 200 due to a sharp edge while the wire 200 is wound may be prevented. Of course, the core 100 may also be provided in a circular cylinder shape or in a polyhedral shape. For example, the core 100 may have a polygonal shape of at least a pentagonal shape when viewed in a plan view or a cross-sectional view in the X-direction, and may be provided in a predetermined length in the X-direction. The flanges 300 may be provided on both end portions of the core 100, that is, on the first and second surfaces in the X-direction. Meanwhile, the core 100 may be manufactured by using a ferrite material. As the ferrite material, one or more selected from the group consisting of nickel (Ni) ferrite, copper (Co) ferrite, manganese (Mn) ferrite, cobalt (Co) ferrite, barium (Ba) ferrite, and nickel-zinc-copper (Ni-Zn-Cu) ferrite, and a ferrite of one or more oxides thereof. The core 100 may be manufactured in such a way that such a ferrite material and, for example, a polymer are mixed, and then, the mixture is formed in a predetermined shape such as a hexahedron.

2. Wire

The wire 200 may be provided to surround the core 100. That is, the wire 200 may be provided to surround the core 100 from one side toward the other side in the X-direction, for example, from the first surface toward the second surface. In addition, the wire 200 may be led out such that both end portions thereof are brought into contact with the terminal electrodes 400 fastened to the flanges 300. The wire 200 may be wound onto the core 100 in at least one or more layers. For example, the wire 200 may include: a first wire to be in contact with and wound around the core 100; and a second wire to be in contact with and wound around the first wire. At this point, both ends of the first wire may extend to the terminal electrodes which are fastened to the two flanges 300 and face each other, and both ends of the second wire may extend to the terminal electrodes which are fastened to the two flanges 300 and face each other and to which the first wire does not extend. Meanwhile, the wire 200 may be formed of a conductive material and be coated with an insulating material so as to be surrounded by the insulating material. For example, the wire 200 may be formed such that a metal wire such as a copper wire is formed in a predetermined thickness, and an insulating material such as a resin coats the metal wire. For the insulating coating, polyurethane, polyester, polyester imide, polyamide imide, polyimide, or the like may be singly used, or a mixture or a laminate of at least two or more thereof may also be used. For example, for the insulating coating, a mixture of polyester and polyamide may be used, or a laminate thereof may also be used. Meanwhile, the insulating coatings on the end portions of the wire 200 brought into contact with the terminal electrodes 400 may be completely removed and the metal wire may thereby be exposed. In order to completely remove the insulating coating, the coating may be irradiated with laser at least two times. For example, the end portions of the wire 200 is irradiated with first laser, and then the portion irradiated with the first laser is irradiated with second laser, whereby the insulating coating may completely be removed. The insulating coatings on the end portions of the wire 200 are completely removed, whereby the insulating coatings are not present between the terminal electrodes 400 and the wire 200. Of course, in the end portions of the wire 200, only a portion of insulating coatings may be removed, the portion contacting the terminal electrodes 400. That is, the insulating coatings in the region contacting the terminal electrodes 400 may be removed, and the insulating coatings in the remaining regions including the opposite region of the region contacting the terminal electrodes 400 may remain.

3. Flange

The flanges 300 are provided on both end portions of the core 100. That is, the flanges 300 are provided on both end portions of the core 100 in the X-direction. The flanges 300 may be provided in a plate shape which has two surfaces facing each other and has a predetermined thickness. That is, the flanges 300 each may have a first surface brought into contact with the core 100 and a second surface facing the first surface, and may have a predetermined thickness in the Y-direction. At this point, in the flanges 300, the two surfaces facing each other in the Y-direction will be referred to as side surfaces, and the two surfaces facing each other in the Z-direction will be referred to as upper and lower surfaces. Thus, the flanges 300 are provided in a plate shape with a predetermined thickness, and each have: first and second surfaces facing each other; two side surfaces which are perpendicular to first and second surfaces in the X-direction and face each other in the Y-direction; and lower and upper surfaces which are perpendicular to the first and second surfaces in the Z-direction and face each other. Here, the thicknesses of the flanges 300, that is the thicknesses in the X-direction may be the same as or greater than the widths of surfaces of the terminal electrodes 400 on to which the wire 200 is led out and mounted. That is, the thicknesses of the flanges 300 may be adjusted according to the widths of the terminal electrodes 400 provided to be in contact with the side surfaces of the flanges 300. Meanwhile, the flanges 300 may be provided to be larger than the core 100 in the Y- and Z-directions. That is, the flanges 300 may have the widths larger than the core 100 in the Y-direction and the heights larger than the core 100 in the Z-direction. In addition, the flanges 300 may have regions having widths smaller than those of other regions thereof in the Y-direction. That is, in the flanges 300, the regions onto which the terminal electrodes 400 are fastened, for example, intermediate regions in the Z-direction may have widths smaller than those of the upper and lower regions. At this point, in the flanges 300, the heights of the intermediate regions having smaller widths may be larger than the heights of the upper and lower regions. For example, in each of the flanges 300, when the lower region with a first width, the intermediate region with a second width smaller than the first width, and the upper region with the first width are formed in the Z-direction, the ratio of the heights of the lower, the intermediate, and the upper regions may be 1:2:1. That is, in each flange 300, the two side surfaces, which face each other in the Y-direction, may form a shape, such as a “laid H” shape, in which the intermediate region is recessed in the up-down direction. Of course, such a ratio of heights may be variously changed, for example, may be changed according to the heights of the terminal electrodes 400 fastened to the flanges 300.

In addition, each flange 300 may have a predetermined inclination in at least a region with which the wire 200 is in contact while being led out. For example, the flanges 300 may have a predetermined inclination in the intermediate region adjacent to the core 100. Of course, as illustrated in FIGS. 1 and 2, each flange 300 may have a recess part 310 in a region which is adjacent to the core 100 in the intermediate region and with which the wire 200 is in contact while being led out. That is, the recess part 310 may be formed in the predetermined region of a surface adjacent to the core 100 and a surface perpendicular thereto in the intermediate region of each flange 300. The recess parts 310 formed as such may function to guide the led-out of the wire 200. That is, the recess parts 310 are provided in the predetermined regions, whereby the wire 200 may be guided by the recess parts 310 and led out onto the terminal electrodes 400. As described above, the regions which are in the flanges 300 and with which the wire 200 is in contact while being led out are rounded or recessed, whereby disconnection, peel-off of coating, and the like of the wire 200 may be prevented. That is, when edges are formed between the two surfaces of the flanges 300 with which the wire 200 is in contact while being led out, the wire 200 may be chopped and the coating of the wire 200 may also be peeled off, or the wire 200 may also be disconnected. However, by rounding the corresponding portions, disconnection or the like of the led out wire 200 may be prevented.

4. 4. Terminal Electrode

The terminal electrodes 400 are inserted into and fastened to the flanges 300, and provided with weld parts 600 formed by fixing the wire 200 in one region of thereof. That is, the weld parts 600 are each formed such that the wire 200 is brought into contact with and fixed onto one surface of each of the terminal electrodes 400 which are provided to be in contact with two side surfaces of each flange 300. The terminal electrodes 400 may be provided in a shape which can be brought into contact with and fastened to a plurality of surfaces of the flanges 300. That is, the terminal electrodes 400 may be provided in shapes brought into at least two surfaces of the flanges 300. For example, as illustrated in FIGS. 1 and 2, the terminal electrodes 400 each may include: a first terminal 410 brought into contact with the second surface of a flange 300; a second terminal 420 brought into contact with the lower surface of the flange 300; and a third terminal 430 brought into contact with a side surface of the flange 300. The first terminal 410 may have an approximately rectangular shape, and have a first side provided at an edge between the second surface and a side surface of the flange 300. In addition, the first terminal 410 includes a portion extending toward the lower surface of the flange 300 with a predetermined width from a second side thereof perpendicular to the first side thereof. At this point, the extension portion may extend up to the edge region between the second surface and the lower surface of the flange 300. Accordingly, the first terminal 410 may be formed in a “F” shape, for example. The second terminal 420 may be formed along the lower surface of the flange 300 perpendicularly from the downwardly extending portion of the terminal 410. At this point, the widths, that is, the widths in the Y-direction of the extension portion of the first terminal 410 and the second terminal 420 may be smaller than the width of the first terminal 410. In addition, the third terminal 430 may be provided along a side surface of the flange 300 from one side of the first terminal 410 corresponding to the edge between the second surface and the side surface of the flange 300. At this point, the third terminal 430 may be provided to be in contact with the recess region provided in the side surface of the flange 300. As described above, the terminal electrodes 400 each may be brought into contact with and fastened to the lower surface and side surfaces from the first surface of the flange 300. Meanwhile, the third terminal 430 may be provided with a recess part 435 on a region facing the core 100, that is, a central part much separated from the first terminal, corresponding to the recess part 310 of the flange 300. The recess part 435 may be provided to guide the led-out of the wire 200. In addition, two terminal electrodes 400 for one flanges 300, and in total, four terminal electrodes may be provided.

Meanwhile, predetermined inclinations are formed between the second surface and the side and lower surfaces of the flanges 300, whereby the second terminal 420 and the third terminal 430 may move along the inclinations to the lower surface and the side surface of the flange 300. In addition, the first terminal 410 and the second and third terminals 420 and 430 may form right angles. However, in order to further enhance the coupling force by a pressing force of any one of the second terminal 420 and the third terminal 430, the first terminal and the second and third terminals 420 and 430 of the terminal electrode 400 may form acute angles less than 90°, such as approximately 88°.

In addition, as illustrated in FIGS. 1, 2, and 7, first and second extension parts 431 and 432 for fixing the ends of the wire 200 may be provided in a region of the terminal electrode 400 on which the wire 200 is mounted, that is, on the third terminal 430. The first extension part 431 temporarily fixes an end of the wire 200, and the second extension part 432 fixes the end of the wire 200 and forms the weld part 600 together with the wire 200. That is, a portion of the wire 200 and the second extension part 432 are melted and the weld part 600 may thereby be formed.

The first extension part 431 may be formed on the third terminal 430 on a third side facing a first side brought into contact with the first terminal 410 of the terminal electrode 400. The first extension part 431 may be formed in a shape of extending in a predetermined height from the third side of the third terminal 430, and then further extending in one direction. That is, the first extension part 431 may include: a height part formed in a predetermined height from the third terminal 430; and a horizontal part extending in one direction from the end of the height part. Accordingly, the first extension part 431 may be formed in a “F” shape. At this point, since the first extension part 431 is formed, the recess part may not be formed in the terminal electrodes 400. Of course, the recess part 435 may be formed and the first extension part 431 may be formed in the terminal electrodes 400, but in this case, the height part of the first extension part 431 may formed adjacent to the recess part. As such, since the first extension part 431 is formed, the wire 200 may be guide by the height part and the horizontal part of the first extension part 431 and be led out. That is, since the wire 200 may be guided between the height part and the horizontal part of the first extension part 431 having a “F” shape, the detachment of the wire 200 may be prevented. In addition, the first extension part 431 may be bent in the led-out direction of the wire 200, that is, in the opposite direction of the core 100. Thus, the horizontal part of the first extension part 431 is brought into contact with the third terminal 430 in a direction perpendicular to the led-out direction of the wire 200 and temporality guides the wire 200.

The second extension part 432 may be provided to be spaced apart from the first extension part 431. For example, the second extension part 432 may be formed on the third terminal 430 on the third side perpendicular to the second side on which the first extension part 431 has been formed. The second extension part 432 may include: a height part provided in a predetermined height over a predetermined region of the third side of the third terminal 430; and a horizontal part formed in a predetermined size from the end of the height part. At this point, the horizontal part may be formed wider than the width of the height part. That is, the horizontal part of the second extension part 432 may be formed larger than the size of the first extension part 431 considering the size of the weld parts 600 and the like. For example, the horizontal part of the second extension part 432 may be formed so as to be widened from the height part in the direction of the first side. In addition, the second extension part 432 may be bent in a direction perpendicular to the bending direction of the first extension part 431. That is, the height part of the first extension part 431 is bent from the second side in the direction of the first side of the third terminal 430, and the second extension part 432 may be bent from the third side in the direction of a fourth side facing the third side of the third terminal 430. Accordingly, the horizontal part of the first extension part 431 and the horizontal part of the second extension part 432 fix the wire 200 in the same direction. As such, the wire 200 may be brought into contact with and fixed onto the third terminal 430 of the terminal electrode 400 by means of the first and second extension parts 431 and 432.

Meanwhile, in the first exemplary embodiment, although the case in which both the first and second extension parts 431 and 432 are provided on the third terminal 430 has been described, only the second extension part 432 may be provided without providing the first extension part 431.

5. Wire Accommodation Part

The wire accommodation parts 500 are provided to accommodate at least a portion of the wire 200 led out onto the terminal electrodes 400 from the core 100. The wire accommodation parts 500 may be provided on at least portions of the terminal electrodes 400. For example, the wire accommodation parts 500, as illustrated in FIGS. 5 and 6, may be provided in predetermined regions of the second extension parts 432. At this point, the wire accommodation parts 500 each may be formed on a surface of the second extension part 432, the portion contacting the wire 200. That is, in the second extension part 432, the horizontal part thereof is bent in one direction, that is, toward the third terminal 430 of the terminal electrodes 400 and may thereby be brought into contact with the wire 200. The wire accommodation parts 500 each may be provided on one surface of the horizontal part brought into contact with the wire 200. For example, the wire accommodation parts 500 each may be provided in a predetermined length on the one surface of the horizontal part in the led-out direction of the wire 200, that is, in the X-direction. Here, the wire accommodation parts 500 each may also be provided, in the X-direction, in the entire length of the horizontal part or in at least a led-out length of the wire 200. The wire accommodation parts 500 each may be provided in a groove shape having predetermined depth and width and a predetermined length. That is, a groove having a predetermined depth and width and a predetermined length is formed in a predetermined region of the second extension part 432, whereby the wire accommodation parts 500 each may be formed. At this point, the shapes of the wire accommodation parts 500 may have various shapes capable of accommodating the wire 200. For example, the wire accommodation parts 500 may be formed in various shapes each having the various cross-sectional shapes, such as, semicircles, ellipses, triangles, rectangles, and pentagons. Meanwhile, the depths and the widths of the wire accommodation parts 500 may be formed to be 0.2 times to 2 times the diameter of the wire 200. Preferably, the depths of the wire accommodation parts 500 may be formed to be 0.2 times to 1 times the diameter of the wire 200, and the widths may be formed to be 0.5 times to 2 times the diameter of the wire 200. At this point, the greater the depths and the widths of the wire accommodation parts 500, the further the wire 200 may be completely accommodated. Thus, the shape deformation of the wire 200 may be minimized. However, the deeper the depths of the wire accommodation parts 500, the greater the thickness of the second extension part 432 may be. When the thickness of the second extension part 432, there may be limitations in that when the weld parts 600 are later formed by using laser, the wire 200 accommodated in the wire accommodation parts 500 under the second extension part 432 is not melted. Accordingly, the depths of the wire accommodation parts 500 may be smaller than the thickness of the thickness of the horizontal part of the second extension part 432. That is, the depths of the wire accommodation parts 500 may be smaller than the thickness of the horizontal part of the second extension part 432 and may be formed to be 0.2 times to 1 times the diameter of the wire 200. Meanwhile, the depths and the widths of the wire accommodation parts 500 are less than 0.2 times the diameter of the wire 200, the wire 200 accommodated in the wire accommodation parts 500 decreases. Thus, the second extension part 432 further presses the wire 200, whereby the effect of preventing the shape deformation of the wire 200 may be decreased. That is, when the depths and widths of the wire accommodation parts 500 are small, the area of the wire 200 accommodated in the wire accommodation parts 500 is small. Thus, the area pressed between the horizontal part of the second extension part 432 and the third terminal 430 is increased, whereby the crushed area of the wire 200 is increased.

6. Weld Part

The weld parts 600 are formed on the third terminals 430 of the terminal electrodes 400 fastened to the side surfaces of the flanges 300. The weld parts 600 may be formed such that the wire 200 is mounted on the terminal electrodes 400, and irradiated with laser while the second extension parts 432 are bent and press the wire 200. That is, the weld parts 600 may be formed by melting the wire 200 on the terminal electrodes 400. In addition, the weld parts 600 may be formed in spherical shapes. Meanwhile, insulating layers may be provided under the weld parts 600. That is, the insulating layers may be provided between the weld parts 600 and the third terminals 430. When the weld parts 600 are formed without completely removing the insulating coating of the wire 200, the insulating layer may remain due to the insulating coating of the wire 200. Of course, when the weld parts 600 are formed after completely removing the insulating coating, the insulating layer may not be provided under the weld parts 600.

7. Lid Part

The lid part 700 may be provided over the core 100 around which the wire 200 is wound and onto which the terminal electrodes 400 are fastened. The lid part 700 may be provided in a shape of an approximately rectangular plate having a predetermined thickness. At this point, the lower surface of the lid part 700 may be brought into contact with the upper surfaces of the flanges 300.

Meanwhile, in order to accommodate and fix the wire 200 on the terminal electrodes 400 and facilitate the formation of the weld parts 600, the terminal electrodes 400 and the wire accommodation parts 500, as illustrated in FIGS. 7 to 10, may be formed in various shapes.

4.1 Modified Example of Terminal Electrode and Wire Accommodation Part

As illustrated in (a) of FIG. 7, an opening part 433 may be formed in a third terminal 430 of a terminal electrode 400. The opening part 433 may be formed in predetermined depth and length, and the wire 200 may be positioned on the opening parts 433. That is, the side surface of a flange 300 may be exposed under the wire 200 by the formation of the opening part 433. At this point, a wire accommodation part 500 which accommodates at least a portion of the wire 200 may be formed in the second extension part 432. In addition, the opening part 433 may be formed in a wider width than the wire 200 and in a shorter length than the wire 200 mounted on the third terminal 430. Thus, the wire 200 may be floated over the opening parts 433 and the endmost portion of the wire 200 may be brought into contact with the third terminal 430. That is, the wire 200 may be brought into contact by a predetermined width from the endmost portion of the wire 200 with, and a portion of the wire 200 may be floated over the opening parts 433. Of course, a portion of the wire 200 may be brought into contact with the flange 300 through the opening part 433. As such, the wire 200 and a second extension part 432 are positioned on the opening parts 433 and the wire and the second extension part are melted by being irradiated with laser, whereby a weld part 600 may be formed. That is, the weld parts 600 may be positioned over the opening parts 433. As such, by the formation of the opening part 433 in the third terminal 430 of the terminal electrode 400, the transfer of energy due to laser irradiation for forming the welding part 600 to the third terminal 430 of the terminal electrode 400 through the wire 200 may be suppressed. Thus, the shape deformation of the third terminal 430 of the terminal electrode 400 due to the heat during laser irradiation may be prevented, and the weld part 600 may be formed by using optimal energy. In addition, thermal energy transferred to the wound wire 200 is decreased, whereby a short circuit may be prevented. In addition, an air layer is formed between the weld part 600 and the flange 300 by the opening part 433, so that a quick cooling effect may be expected after forming the weld part 600, and the shape of the weld part 600 may thereby be stably maintained.

In addition, a portion of the weld part 600, formed while the wire 200 and the second extension part 432 of the terminal electrode 400 are welded, is positioned over the opening parts 433 of the terminal electrode 400, whereby the height of the weld part 600 may be lowered. Thus, the area of a height space of the weld part 600 in the Z-direction may maximally be used, whereby product miniaturization and a low-profile design become possible.

Meanwhile, as illustrated in (b) of FIG. 7, an opening part 433 may be formed in a second extension part 432. By the formation of the opening part 433 in the second extension part 432, a space in the height direction of a weld part 500, that is, the space in the Z-direction, may be maximally used, whereby miniaturization and a low-profile design become possible.

In addition, as illustrated in FIG. 8, the end of a horizontal part of a second extension part 432 may be formed in a “U” shape, and a height part and a horizontal part may be formed in an approximate “F” shape. That is, the horizontal part may be formed in an approximate “U” shape in the direction facing a core 100 so that a groove is formed in a region through which a wire 200 passes and a protrusion part is formed on both sides of the groove. Of course, a wire accommodation part 500 which accommodates at least a portion of the wire 200 may also be formed in the second extension part 432 having an “F” shape. At this point, the protrusion parts on both sides may extend to the outside of a terminal electrode 400. That is, the portion protruding in the “U” shape extends up to a region exceeding a first terminal 410 of the terminal electrode 400 assuming the case in which the first terminal 410 of the terminal electrode 400 vertically extends. The second extension part 432 is bent in the direction of a fourth side from a third side of a third terminal 430. Accordingly, in the second extension part 432, the wire 200 passes through the groove part in the “U”-shaped portion, and the protrusion parts on both sides thereof extend to pass through the first terminal 410. As such, the wire 200 may be brought into contact with and fixed onto the terminal electrode 400 by means of the second extension part 432. In addition, since the protrusion parts of the second extension part 432 protrudes to the outside of the first terminal of the terminal electrodes 400, the protruding portion of the terminal electrodes 400 and the wire 200 may be joined by laser welding, and the wire 200 over the terminal electrodes 400 is not peeled off, whereby excessive welding may be prevented.

Meanwhile, the wire accommodation part 500 may also be formed on the third terminal 430 of the terminal electrode 400. That is, as illustrated in FIG. 9, a groove-shaped wire accommodation part 500 having a predetermined depth and width and a predetermined length may be formed on a third terminal 430. As such, the wire accommodation part 500 is formed on the third terminal, whereby the wire 200 may be accommodated and fixed while being guided. That is, the wire 200 is led out so as to be in contact with the third terminal 430, and the led-out wire 200 may be guided so as to be accommodated in the wire accommodation part formed in the third terminal 430, and the wire 200 may be accommodated and fixed. Of course, the wire accommodation part 500 may be formed not only in the third terminal 430, but also in the second extension part 432 facing the third terminal 430. Meanwhile, when the wire accommodation part 500 is formed in the third terminal 430, the depth of the wire accommodation part 500 may be formed smaller than the thickness of the third terminal 430.

In addition, the wire accommodation part 500 may be formed in the depth equal to or greater than the thickness of the second extension part 432, and to this end, a portion of the second extension part 432 may protrude. That is, as illustrated in FIG. 10, the wire accommodation part 500 is formed to be recessed toward the inside of the second extension part 432, and one surface of the second extension part 432 facing the surface, in which the wire accommodation parts 500 is formed, may protrude according to the depth of the accommodation part 500. As such, one surface of the second extension part 432 is recessed and the other surface thereof protrudes, whereby the wire accommodation part 500 may be formed in a depth regardless of the thickness of the second extension part 432. That is, the wire accommodation part 500 may be formed in a depth equal to or greater than the thickness of the second extension part 432.

In addition, the wire accommodation part 500 may be formed not only in the second extension part 432 but also in the third terminal 430 of the terminal electrode 400. That is, as illustrated in FIG. 11, a wire accommodation part 500 may include a first wire accommodation parts 510 formed in a second extension part 432 and a second wire accommodation parts 520 formed in a third terminal 430. At this point, the first and second wire accommodation parts 510 and 520 may be formed in regions overlapping each other. That is, the first and second wire accommodation parts 510 and 520 are formed in the same region, so that a portion of the diameter of a wire 200 is led out so as to be accommodated in the second wire accommodation part 520, and then the remaining portion of the diameter of the wire 200 may be accommodated in the first wire accommodation part 510 when the second extension part 432 is bent. In addition, the first and second wire accommodation parts 510 and 520 may have the same depth and width. However, the first and second wire accommodation parts 510 and 520 may also have different depths and widths. For example, the second wire accommodation part 520 formed in the third terminal 430 may have larger depth and width than the first wire accommodation part 510. Of course, conversely, the first wire accommodation part 510 formed in the second terminal 432 may have larger depth and width than the second wire accommodation part 520.

As described above, a choke coil in accordance with the first exemplary embodiment is provided with wire accommodation parts 500 which accommodate at least a portion of the wire 200 on portions of terminal electrodes 400, whereby the crush and positional misalignment of the wire 200 may be prevented. That is, when the wire 200 led out onto the third terminals of the terminal electrodes 400 is pressed by at least portions of the terminal electrodes 400, such as the second extension part 432, the wire accommodation parts 500 provided in the second extension parts 432 accommodate the wire 200, whereby the crush and positional misalignment of the wire 200 may be prevented. Thus, the tensile force of the wire may be improved, whereby resistance against shock and vibration may be improved, and the reliability of the choke coil may be improved. In addition, positional deviation of the wire may not occur, and thus, in a subsequent process, the same quality may be expected in coupling the wire and the terminal electrodes.

In addition, flanges 300 are provided on both end portions of the core 100 around which the wire 200 is wound, and the terminal electrodes 400 are fastened to at least side surfaces of the flanges 300. In addition, an inclined surface (or rounded surface) is formed on an edge portion of each of the flanges 300, on which the terminal electrode 400 is fastened, and facilitates the fastening of the terminal electrode 400, whereby the disconnection of the wire 200 led out to the third terminal 430 of the terminal electrode 400 may be prevented. As such, since the terminal electrodes 400 are provided on side surfaces of the flanges 300, and the wire 200 is led out to the side surfaces of the flanges 300, the phenomenon of crush of a first wire by a second wire may be prevented, and thus, the positional misalignment of the first wire may be prevented.

In addition, by the formation of opening parts 433 in the third terminals 430 on which the wire 200 is mounted, the transfer of energy due to laser irradiation for forming the welding part 600 to the third terminals 430 of the terminal electrodes 400 through the wire 200 may be suppressed. Thus, the shape deformation of the terminal electrodes 400 due to the heat generated during laser irradiation may be prevented, weld parts 600 may be formed by using optimal energy, and the thermal energy transferred to the wound wire 200 may be decreased, whereby short-circuit may thereby be prevented.

A method for manufacturing a choke coil in accordance with an exemplary embodiment will be described as follows.

Firstly, a core 100, both ends of which are respectively coupled to flanges 300, and a lid part 700 are manufactured. The core 100 has approximately rectangular cross-sectional shapes in the longitudinal direction (X-direction) and the width direction (Y-direction), respectively, and the core 100 may be provided in an approximately hexagonal shape with a larger size in the X-direction than in the Y-direction. In addition, the core 100 may be formed to have a rounded edge and have a predetermined inclination. The flanges 300 may be provided on both end portions of the core 100 in the X-direction, be integrally manufacture with the core 100, and also be separately manufactured and coupled to the core 100. At this point, the flanges 300 may be provided so as to have predetermined curvatures in side surfaces in the height direction, that is, in the Z-direction. That is, the flanges 300 each may be provided such that a central portion thereof has a smaller width in the height direction than upper and lower portions thereof. In addition, in each of the flanges 300, a recess part may be formed in a predetermined portion of the central portion, and the edges between a first surface which face the core 100 and side surfaces may be roundly formed. Meanwhile, a lid part 700 may be provided in a shape of an approximately rectangular plate having a predetermined thickness.

Subsequently, terminal electrodes 400 are inserted so as to be brought into contact with the side surfaces and the lower surface of the flanges 300 and are coupled to the flanges 300. To this end, the terminal electrodes 400 each may be provided so as to include: a first terminal 410 brought into contact with the second surface of a flange 300; a second terminal 420 extending from the first thermal 410 and brought into contact with the lower surface of the flange 300; and a third terminal 430 extending from the first terminal 410 and brought into contact with a side surface of the flange 300. At this point, edge portions between the second surface, and the lower and side surfaces of the flange 300 are roundly formed, and the terminal electrode 400 may move to the side surface and the lower surface of the flange 300 along the rounded portions.

Subsequently, the wire 200 is wound to surround the core 100. That is, the wire 200 may surround the core 100 from one side to the other side in the X-direction. The wire 200 may include: a first wire to be in contact with and wound around the core 100; and a second wire to be in contact with and wound around the first wire. Both ends of the first wire may extend to the third terminals 430 of the terminal electrodes 400 fastened to the two flanges 300 facing each other, and both ends of the second wire may extend to the third terminals 430 of the terminal electrodes 400 respectively fastened to the two flanges 300 which face each other and to which the first wire does not extend. At this point, when the first and second wires are led out, the phenomenon in which the first wire is crushed by the second wire may be prevented, and thus, the positional misalignment of the first wire may be prevented. Meanwhile, the wire 200 may be formed of a conductive material and be coated with an insulating material so as to be surrounded by the insulating material. For example, the wire 200 may be formed such that a metal wire such as a copper wire is formed in a predetermined thickness and an insulating material such as a resin coats the metal wire. After the wire 200 is wound, the coating on the end portions of the wire 200 may be peeled off. The end portions of the wire 200 are peeled off so that all the coatings surrounding the metal wire are removed. To this end, a laser is provided over the wire 200, the upper portion of the wire 200 is then irradiated with the laser, and then, the wire 200 is rotated so that a region which is not irradiated with the laser faces upward, and then the wire 200 may be irradiated again with laser.

Meanwhile, an insulating material is not removed from regions in which the wire 200 is brought into contact with the terminal electrodes 400, and the insulating material in end regions out of the terminal electrodes 400 is removed. That is, the end portions of the wire 200 positioned out of the terminal electrodes 400 before forming the weld parts 600 are irradiated with laser at least once, and at least a portion of the coating may thereby be removed. That is, the end portions of the wire 200 positioned out of the terminal electrodes 400 are irradiated with laser from over such that the coating of the upper side may thereby be removed and the coating of the lower side may remain. Alternatively, the coatings of the end portions of the wire 200 may completely be removed by being irradiated with laser from the upper side and lower side respectively. Of course, laser may also be emitted from under such that the coatings on the lower portion of the end portions of the wire 200 are removed and the upper side coatings remain. Consequently, the insulating coatings may be at least partially removed by a laser irradiation method from the end portions out of the terminal electrodes 400 in the direction in which the wire 200 is led out. As such, the insulating coatings are not removed from the wire 200 positioned on the terminal electrodes 400, and the insulating coatings of the end portions of the wire 200 are partially removed, whereby when the weld parts 600 are formed, insulating layers are present between the wire 200 and the terminal electrodes 400 due to the insulating coatings of the wire 200. In addition, insulating layers may remain in at least a region of the weld parts 600 and also in the remaining regions. That is, the wire 200 and the terminal electrodes 400 are present under the weld parts 600, and the insulating layers may remain between the weld parts 600 and the wire 200 and between the wire 200 and the terminal electrodes 400. In addition, the insulating layers may remain also on the surfaces of the weld parts 600 or the like. Consequently, the insulating layers may be present in a plurality of regions around the weld parts 600. This is because the weld parts 600 are formed in a state in which the insulating coating of the wire 200 is not removed between the weld parts 600 and the terminal electrodes 400, and the insulating coating of the wire 200 is removed in a region out of the terminal electrodes 400.

Subsequently, ends of the wire 200, that is, end portions of the wire 200 from which the coating is peeled off are led out to the third terminals of the terminal electrodes 400. At this point, recess parts or inclined surfaces may be formed between the first surfaces and the side surfaces of the flanges 300, and the wire 200 may be led out along the recess parts or the inclined surfaces. In addition, first extension parts 431 each configured from a height part and a horizontal part and having approximately a “F” shape may be formed on the third terminal 430 of the terminal electrode 400. Therefore, the wire 200 is guided between the height part and the horizontal part and is positioned on the third terminal 430 of the terminal electrode 400. At this point, opening parts 433 are formed in the third terminals 430 of the terminal electrodes 400, and the wire 200 may also be mounted over the opening part 433. Thus, portions of the wire 200 are positioned on the opening parts 433. Meanwhile, opening parts 433 are formed in the third terminals 430 of the terminal electrodes 400, the wire 200 is led out to pass through over the opening part 433. As such, after the wire 200 is mounted, the first extension parts 431 are bent and temporarily fix the wire 200. Subsequently, the second extension parts 432 are bent and fix the wire 200. Since wire accommodation parts 500 are provided in the second extension parts 432, when the second extension parts 432 are bent, at least a portion of the wire 200 may be accommodated in the wire accommodation parts 500. Accordingly, when the second extension parts 432 are bent, the crush or positional misalignment of the wire 200 may be prevented.

Subsequently, the second extension parts 432 are irradiated with laser, whereby the weld parts 600 are formed. That is, the second extension parts 432 and the wire 200 are melted by being irradiated with laser, and thus, the spherical weld parts 600 are formed on the terminal electrodes 400. Here, when the opening parts are formed in the terminal electrodes 400, the weld parts 600 may be formed over the opening parts. The opening parts are formed in the terminal electrodes 400, whereby energy due to the laser irradiation for forming the weld parts 600 may be prevented from being transferred to the terminal electrodes 400 through the wire 200. Thus, the shape deformation of the terminal electrodes 400 due to the heat during laser irradiation may be prevented, and the weld parts 600 may be formed by using optimal energy. In addition, thermal energy transferred to the wound wire 200 is decreased, whereby short-circuit may be prevented. In addition, an air layer is formed between the weld parts 600 and the flanges 300 by the opening parts 433, so that a quick cooling effect may be expected after the formation of the weld parts 600, and the shape of the weld parts 600 may be stably maintained.

Subsequently, a lid part 700 covers the upper portions of the flanges 300 so as to be in contact with the upper part of the flanges 300.

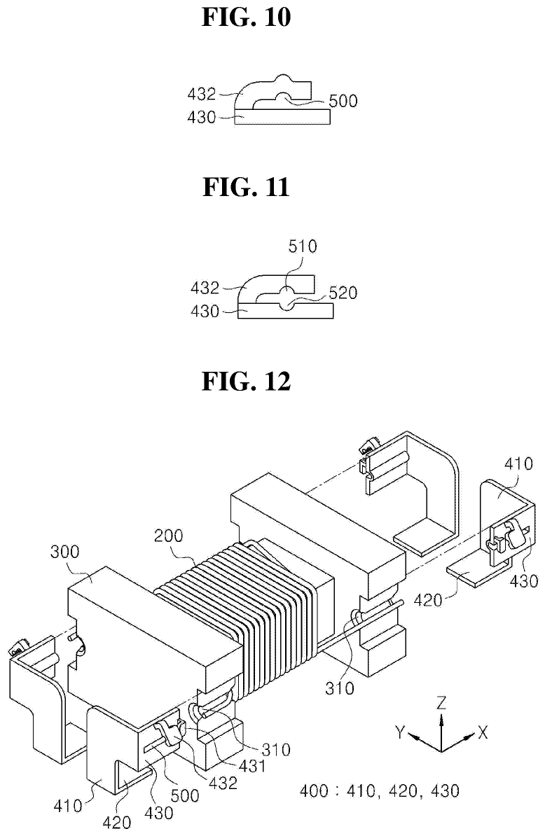

FIGS. 12 and 13 are an exploded perspective view and an assembled perspective view of a choke coil in accordance with a second exemplary embodiment.

Referring to FIGS. 12 and 13, a choke coil in accordance with a second exemplary embodiment may have: grooves 310 on side surfaces of the flanges 300, and wire accommodation parts 500 formed corresponding to the grooves 310 in terminal electrodes 400 fastened to the flanges 300. That is, compared to the first exemplary embodiment, the second exemplary embodiment may further be provided with: the grooves 310 formed in the side surfaces of the flanges 300; and the wire accommodation parts 500 formed in terminal electrodes 400 corresponding to the grooves 310. The terminal electrodes 400 each include: a first terminal 410 brought into contact with the front surface of a flange 300; a second terminal 420 brought into contact with the lower surface of the flange 300; and a third terminal 430 brought into contact with the side surface of the flange 300, wherein wire accommodation parts 500 are each formed in the third terminal corresponding to the groove 310 of the flange 300. Here, when the terminal electrodes 400 are fastened to the flanges 300, the wire accommodation parts 500 are inserted into the grooves 310 of the flanges 300, and the wire accommodation parts 500 may be formed to be further recessed than the surfaces of the third terminals 430. Accordingly, the wire 200 may be accommodated in and led out from the wire accommodation parts 500. Here, the wire accommodation parts 500 may have depths and widths of 0.2 times to 2 times the diameter of the wire 200 so that at least a portion of the wire 200 may be accommodated therein, and preferably, have depths and widths of 0.5 times to 1 times the diameter of the wire 200. As such, the grooves 310 are formed in the side surfaces of the flanges 300, and the wire accommodation parts 500 are formed in the terminal electrodes 400 so as to be fastened to the grooves 310. Therefore, the terminal electrodes 400 may further be firmly fastened to the flanges 300. That is, besides the first to third terminals 410, 420 and 430 of the terminal electrodes 400, the wire accommodation parts 500 are further provided. Thus, the contact areas between the terminal electrodes 400 and the flanges 300 are further increased, whereby the fastening of the flanges 300 and the terminal electrodes 400 may be further reinforced. In addition, the wire 200 may further easily be led out through the wire accommodation parts 500 of the terminal electrodes 400.

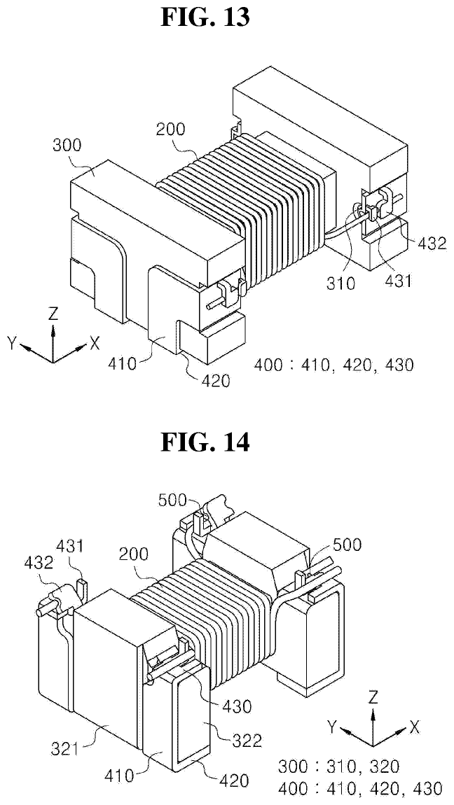

Meanwhile, choke coils in accordance with exemplary embodiments may also be applied to a case in which the wire 200 is led out upward from the flanges 300. That is, also in the case in which “C”-shaped terminal electrodes 400 are fastened to the flanges 300, and the wire 200 is led out to the terminal electrodes 400 over the flanges 300, the wire accommodation parts 500 are formed and may accommodate at least a portion of the wire 200. A choke coil in accordance with such a third exemplary embodiment will be described as follows with reference to FIGS. 14 to 18.

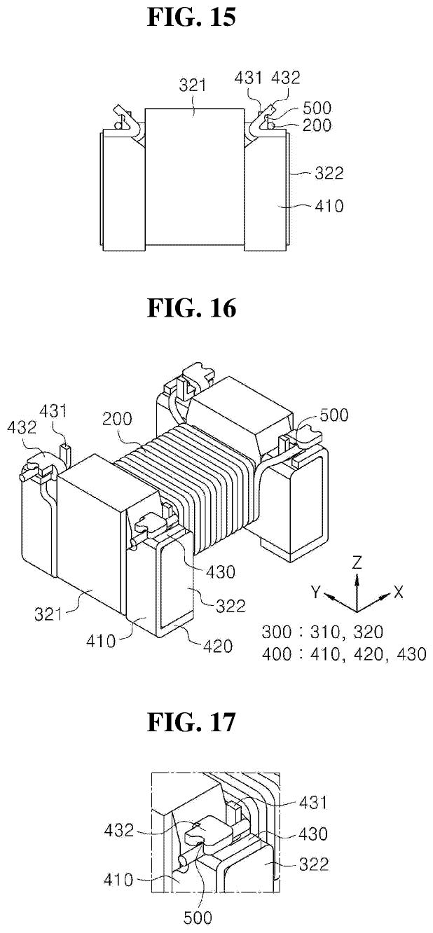

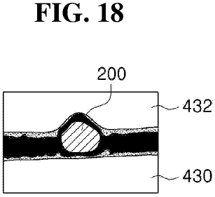

FIGS. 14 to 15 are a perspective view and one side view of a choke coil during some processes in accordance with the third exemplary embodiment, and FIGS. 16 to 17 are a perspective view and a partial enlarged view of a choke coil during some processes in accordance with the third exemplary embodiment. That is, FIGS. 14 and 15 are a perspective view and one side view before a portion of terminal electrodes fixes a wire, and FIGS. 16 and 17 are a perspective view and one side view after a portion of terminal electrodes fixes a wire. Also, FIG. 18 is a partial photograph of a choke coil in accordance with exemplary embodiments, and is a photograph in a state in which a wire is accommodated in wire accommodation parts and clamped by terminal electrodes.

Referring to FIGS. 14 to 17, a choke coil in accordance with the third exemplary embodiment may include: a core 100; a wire 200 wound around the core 100; flanges 300 provided on both end portions of the core and provided such that both sides thereof have lower heights than central portions thereof; terminal electrodes 400 fastened to both sides of the flanges 300; and wire accommodation parts 500 configured to accommodate wire 20 led out onto the terminal electrodes 400 over the flanges 300. In addition, although not shown, weld parts formed over the terminal electrodes 400; and a lid part provided over the core 100 may further be provided. Such a third exemplary embodiment will be described as follows centering on the contents differing from the first and second exemplary embodiments. That is, since the third exemplary embodiment differs from the first and second exemplary embodiments in the shapes of the flanges and the terminal electrodes, the third exemplary embodiment will be described centering on the flanges and the terminal electrodes.

The flanges 300 are provided on both end portions of the core 100 in an X-direction. The flanges 300 each may include: a first region 321 brought into contact with the core 100; and second regions 322 which are provided on both sides of the first region 321 and are not brought into contact with the core 100.

The first and second regions 321 and 322 of the flanges 300 may be formed to have predetermined depths, widths, and heights, respectively.

At this point, the core 100 is provided on first surfaces of the first regions 321, and second regions are provided on two side surfaces of each first region 321. Meanwhile, the first regions 321 may be formed higher than the second regions 322. That is, after the weld parts are formed, the first and second regions 321 and 322 may be formed in a height such that the first regions 321 are brought into contact with the lower surface of the lid part, and the weld parts are not in contact with the lid part in the second regions 322. At this point, the first regions 321 may be formed in a height such that the weld parts are not in contact with the lid part considering the heights of the second regions and the heights of the weld parts. In addition, the first regions 321 may be formed to have widths and lengths larger than those of the second regions 322. Accordingly, steps may be formed between the upper surfaces of the first regions 321 and the upper surfaces of the second regions 322, and steps may be formed between the front surfaces of the first regions 321 and the front surfaces of the second regions 322.

The “C”-shaped terminal electrodes 400 are fastened to the second regions 322 of the flanges 300. That is, the terminal electrodes 400 are inserted form one side to the other side in the X-direction and fastened to the second regions 322 of the flanges 300. At this point, portions between the upper surfaces and the surfaces (that is, front surfaces) of the second regions 322 in the direction of fastening the terminal electrodes 400 may have predetermined inclinations (that is, slopes). That is, in the second regions 322, inclined regions having predetermined inclinations may be formed between the front surfaces and the upper surfaces, that is, between first surfaces and sixth surfaces. In other words, edges are not formed between the front and upper surfaces and may have predetermined inclinations. At this point, the inclined regions may also be roundly formed so as to have predetermined curvatures, and also be formed to have predetermined inclinations from the upper surfaces to the front surfaces. As such, predetermined inclinations are formed between the front surfaces and the upper surfaces, the upper surfaces of the terminal electrodes 400 move along the inclinations, and thus, the terminal electrodes 400 may further easily be fastened.

In addition, in the second regions 322 of the flanges 300, not only first inclined regions with predetermined widths may be formed between the front surfaces and upper surfaces (that is, between first and sixth surfaces), but also second inclination regions with predetermined widths may be formed between the rear surfaces and upper surfaces (that is, between second and sixth surfaces). At this point, the second inclined regions may also be roundly formed so as to have predetermined curvatures, and also be formed to have predetermined inclinations from the upper surfaces to the rear surfaces. As such, predetermined inclinations are formed between the rear surfaces and the upper surfaces, so that the wire 200 led out to the terminal electrodes 400 is guided along the rounded portions, and disconnection, peel-off of coating, or the like of the wire 200 may be prevented. That is, when edges are formed between the rear and upper surfaces of the second regions 322 of the flanges 300 with which the wire 200 is in contact while being led out, the wire 200 may be chopped and the coating of the wire 200 may also be peeled off or also be disconnected. However, by rounding the corresponding portion, disconnection or the like of the led out wire 200 may be prevented.

The terminal electrodes 400 are inserted into and fastened to the second regions 322 of the flanges 300 and fix the wire 200 from the above. The terminal electrodes 400 may be formed in approximate “C” shapes so as to be inserted into and fastened to the flanges 300. That is, the terminal electrodes 400 each may include: a first terminal 410 brought into contact with the front surface of a second region 322 of a flange 300; a second terminal brought into contact with the lower surface of the second region 322; and a third terminal 430 brought into contact with the upper surface of the second region 322. That is, in the first and second exemplary embodiments, the third terminals 430 are brought into contact with the side surfaces of flanges 300, but in the third exemplary embodiment, the third terminals are brought into contact with the upper surfaces of the flanges 300. Accordingly, in each of the terminal electrode 400, the first terminal 410, the second terminal 420, and the third terminal 430 may form an approximate “C” shape. Here, the third terminal 430 may be provided in an approximately rectangular plate-shape. That is, the third terminals 430 each may include: a first side brought into contact with a first terminal 410; a second side facing the first side; a third side brought into contact with a step part of the first and second regions 310 and 320 of a flange 300 between the first and second sides; and a fourth side facing the third side. The terminal electrodes 400 are inserted into the second regions 322 of the flanges 300 from open regions facing the first terminals 410, and the second and third terminals 420 and 430 are brought into contact with the lower and upper surfaces of the second regions 322, and the first terminals 410 are brought into contact with the front surfaces of the second regions 322, whereby the terminal electrodes 400 are fastened to the flanges 300. At this point, since predetermined inclinations are formed between the upper and front surfaces of the second regions 322, the third terminals 430 of the terminal electrodes 400 may move to the upper surfaces of the flanges 300 along the inclined surfaces. First and second extension parts 431 and 432 may be formed in the third terminals 430 of the terminal electrodes 400 to fix the ends of the wire 200. The first and second extension parts 431 and 432 are the same as those described in the first embodiment and the modified example thereof, and thus, detailed description thereon will not be provided.

In addition, the wire accommodation part 500 may be provided on at least portions of the terminal electrodes 400. For example, as illustrated in FIGS. 14 to 17, groove-shaped wire accommodation parts 500 having predetermined diameters and widths and predetermined lengths may be formed on one surfaces of the second extension parts 432. Although not shown, of course, the wire accommodation parts 500 may also be formed in the third terminals 430, and also be formed in both the third terminals 430 and the second terminals 432. As such, the wire accommodation parts 500 are provided, whereby the wire 200 led out onto the third terminals 430 may be accommodated and fixed as illustrated in FIGS. 16 and 17. FIG. 18 is a photograph in which the second extension parts 432 are bent and the wire 200 is accommodated in the wire accommodation parts 500 formed in the second extension parts 432.

As described above, in the exemplary embodiments, wire accommodation parts are provided on at least portions of terminal electrodes, whereby shape deformation of the wire is minimized and the positional misalignment of the wire may be prevented. The degrees of shape deformation according to a pressing force in a related example, in which wire accommodation parts are not provided, and in an exemplary embodiment, in which wire accommodation parts are provided, are shown in Table 1 and Table 2 below.

Table 1 shows heights and pressed degrees of a wire according to a pressing force of a choke coil according to related art which does not include wire accommodation part, and Table 2 shows heights and pressed degrees of a wire according to a pressing force of a choke coil in accordance with an exemplary embodiment which includes wire accommodation parts. Here, the height of the wire is the height of the wire between a second extension part and a third terminal after the wire is pressed. In addition, the pressed degree of the wire is the height of the wire with respect the initial diameter of the wire and is represented with the “-” sign because the height of the wire is reduced compared to the diameter of the wire. In addition, the diameter of the wire was set to 70 urn, and in the exemplary embodiment, and a wire led-out part was formed in various widths in the second extension part.

TABLE 1

| | 8N | | 6N | | 4N | |
|---|---|---|---|---|---|---|
| | Wire | Wire | Wire | Wire | Wire | Wire |
| | heigtht | pressed | heigtht | pressed | heigtht | pressed |
| | (μm) | degree | (μm) | degree | (μm) | degree |
| Average | 18 | −74.2% | 23 | −67.1% | 38 | −45.7% |
| Maximum | 16 | −77.1% | 18 | −74.3% | 31 | −55.7% |
| Minimum | 24 | −65.7% | 30 | −57.1% | 43 | −38.6% |

As shown in Table 1, the larger the force of pressing the wire, the greater the shape deformation, that is, the degree of crush of the wire. Thus, it can be found that the height of the wire is decreased, and the degree of crush is increased. Accordingly, the further the wire is pressed, the weaker the tensile strength of the wire and quality degradation may be caused.

TABLE 2

| | | 0.04 mm | | 0.06 mm | | 0.08 mm | |
|---|---|---|---|---|---|---|---|
| | | Wire | Wire | Wire | Wire | Wire | Wire |
| | | heigtht | pressed | heigtht | pressed | heigtht | pressed |
| | | (μm) | degree | (μm) | degree | (μm) | degree |
| 4N | Average | 55 | −21.4% | 55 | −21.4% | 62 | −11.4% |
| | Maximum | 41 | −41.4% | 46 | −34.3% | 56 | −20.0% |
| | Minimum | 64 | −8.6% | 64 | −8.6% | 67 | −4.3% |
| 6N | Average | 36 | −48.6% | 40 | −42.9% | 55 | −21.4% |
| | Maximum | 30 | −57.1% | 38 | −45.7% | 52 | −25.7% |
| | Minimum | 42 | −32.9% | 45 | −35.7% | 60 | −14.3% |

However, as shown in Table 2, in the exemplary embodiment, it can be found that the pressed degree of the wire, that is, the shape deformation of the wire is smaller than that in the related art, and thus, the height of the wire is also higher than that in the related art. In addition, it can be found that the closer the width of the wire accommodation part to the diameter of the wire, the further the pressed degree of the wire is improved. That is, it can be found that the pressed degree of the wire is further improved when the width of the wire accommodation parts is 0.06 mm than that in the case of 0.04 mm, and still further improved in the case of 0.08 mm than 0.06 mm Thus, when the width of the wire accommodation part is greater than the diameter of the wire, a maximized effect may be expected.

Choke coils in accordance with exemplary embodiments each include wire accommodation parts formed on at least a portion of terminal electrodes, and a wire is led out so that at least a portion of the wire is accommodated in the wire accommodation part. At least a portion of the wire, for example, a least a portion of the diameter of the wire is accommodated in the wire accommodation part, and thus, when the wire is pressed, shape deformation of the wire may be minimized Thus, the tensile force of the wire in improved, resistance against shock and vibration is thereby improved, and the reliability of the choke coil may be improved.

In addition, since the wire is led out so as to be accommodated in the wire accommodation part, the position of the wire may be fixed and the positional misalignment of the wire may be prevented. Accordingly, since positional deviation of the wire does not occur, a weld parts at which the wire and the terminal electrodes are coupled may be formed at the same position, and thus, a plurality of products may have the same quality.

Meanwhile, the technical idea of the present invention has been specifically described with respect to the above embodiments, but it should be noted that the foregoing embodiments are provided only for illustration while not limiting the present disclosure. In addition, various embodiments may be provided to allow those skilled in the art to understand the scope of the preset invention.

1. A choke coil comprising:
a core;
a flange provided on each of both end portions of the core in one direction;
a terminal electrode coupled to the flange;
a wire wound around the core and having end portions each led out to the terminal electrode; and
a wire accommodation part configured to accommodate each of the end portions of the wire.

2. The choke coil of claim 1, wherein the wire accommodation part is provided on at least a portion of the terminal electrode.

3. The choke coil of claim 2, wherein the terminal electrode comprises: a terminal brought into contact with a side surface or one vertical surface of each of the flanges in the horizontal direction of each flange, and the wire is led out on to the terminal.

4. The choke coil of claim 3, further comprising an extension part extending in one direction from the terminal and bent toward the terminal.

5. The choke coil of claim 4, wherein the wire accommodation part is provided on at least one of the terminal and the extension part.

6. The choke coil of claim 5, wherein the wire accommodation part comprises a groove having a depth of 0.2 times to 1 times a wire diameter and a width of 0.2 times to 2 times the wire diameter.

7. The choke coil of claim 6, wherein the groove is provided in at least one of one surface of the terminal and one surface of the extension part which face each other.

8. The choke coil of claim 7, wherein the wire accommodation part further comprises a protrusion part opposed to the groove and provided on the other surface of the terminal and the other surface of the extension part.

9. The choke coil of claim 8, wherein the flange comprises a guide groove recessed corresponding to the protrusion part of the terminal and configured to accommodate the protrusion part.

10. The choke coil of claim 1, further comprising an opening provided to overlap the wire accommodation part.

11. The choke coil of claim 1, further comprising at least one of a weld part formed on the wire accommodation part and a lid part provided to cover the core.
